(19) United States
(12) Patent Application Publication
(10) Pub. No.: US 2009/0252081 A1
(43) Pub. Date: Oct. 8, 2009

(54) APPARATUS AND METHOD FOR SUPPORTING VARIOUS SYSTEMS IN A MULTIHOP RELAY BROADBAND WIRELESS COMMUNICATION SYSTEM

(75) Inventors: Hyun-Jeong KANG, Seoul (KR); Taori RAKESH, Suwon-si (KR); Young-Bin CHANG, Anyang-si (KR); Jung-Je SON, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/418,998

(22) Filed: Apr. 6, 2009

(30) Foreign Application Priority Data
Apr. 7, 2008 (KR) 10-2008-0032402

(51) Int. Cl. H04B 7/14; H04W 4/00; H04W 72/04

(52) U.S. Cl. 370/315; 370/338; 370/336

(57) ABSTRACT

A mobile station compliant with a legacy system and a mobile station compliant with a new system are both supported in a multihop relay broadband wireless communication system. A DownLink (DL) period of the Base Station (BS) includes a legacy zone for communicating with entities of a legacy system and a new zone for communicating with entities of a new system. Operations of the BS include transmitting DL data to entities of the legacy system via the legacy zone, and transmitting DL data to entities of the new system via the new zone which follows the legacy zone in a time axis.

### PRIORITY

The present application claims the benefit under 35 U.S.C. §119(a) of a Korean patent application filed in the Korean Intellectual Property Office on Apr. 7, 2008 and assigned Serial No. 10-2008-0032402, the entire disclosure of which is hereby incorporated by reference.

### BACKGROUND OF THE INVENTION

1. Field of the Invention

The present invention relates to an apparatus and a method for supporting various systems in a multihop relay broadband wireless communication system. More particularly, the present invention relates to an apparatus and a method for communicating based on a frame structure supporting various systems at the same time in a multihop relay broadband wireless communication system.

2. Description of the Related Art

A fourth generation (4G) communication system, which is a next generation communication system, aims to provide services with various Quality of Service (QoS) levels at a transfer rate of about 100 Mbps. More particularly, the 4G communication systems are advancing in order to guarantee mobility and QoS in Broadband Wireless Access (BWA) communication systems such as wireless Local Area Network (LAN) systems and wireless Metropolitan Area Network (MAN) systems. Representative examples include the Institute of Electrical and Electronics Engineers (IEEE) 802.16d and 802.16e communication systems. The IEEE 802.16d and 802.16e communication systems adopt Orthogonal Frequency Division Multiplexing (OFDM)/Orthogonal Frequency Division Multiple Access (OFDMA) scheme for physical channels.

In the conventional IEEE 802.16e communication system, signaling is carried out through a direct link between a fixed Base Station (BS) and a Mobile Station (MS). Hence, it is easy to establish a radio communication link of high reliability between the BS and the MS. However, since the location of the BS is fixed in the IEEE 802.16e communication system, flexibility in the wireless network configuration is quite low. Accordingly, it is hard to expect efficiency of a communication service in a wireless environment when there is a significant change of the traffic distribution or the traffic requirement. To overcome those shortcomings, the conventional cellular wireless communication systems such as the IEEE 802.16e communication system may employ a multihop relay data transfer scheme using a fixed Relay Station (RS), a mobile RS, or MSs.

The multihop relay wireless communication systems may re-configure a network by promptly coping with the communication environment change and more efficiently make use of the entire radio network. For example, the multihop relay wireless communication systems may extend a cell service coverage area and increase a system capacity. More specifically, given a poor channel condition between the BS and the MS, the wireless communication system installs an RS between the BS and the MS and builds a multihop relay path via the RS, thereby providing a better radio channel to the MS. In a cell boundary of a bad channel from the BS, the wireless communication system may provide a faster data channel and extend the cells service coverage area by virtue of the multihop relay scheme.

For example, the multihop relay wireless communication system may be constituted as shown in FIG. 1. FIG. 1 illustrates a conventional IEEE 802.16j wireless communication system and a frame structure. The BS (16MR-BS) of FIG. 1 may use the relay service of the RS (16j RS) to provide the communication service to the MS (16e MS) which travels outside the service coverage area of the BS (16MR-BS). For doing so, physical frame structures need to be defined to determine when the BS, the RS, and the MS should transmit and receive data to and from one another.

A downlink period and an uplink period of the BS are each divided into an access zone and a relay zone. The BS or the RS transmits data to the MS in the access zone of the downlink period, and the BS transmits downlink data used to provide the relay service to the MS, to the RS in the relay zone of the downlink period. The MS transmits data to the BS or the RS in the access zone of the uplink period, and the RS transmits uplink data used to provide the relay service to the MS, to the BS in the relay zone of the uplink period.

As stated above, the RS enables the multihop relay communication. However, the multihop relay communication of FIG. 1 is feasible when all of the BS, the RS, and the MS conform to the same system. If any one of the BS, the RS, and the MS conforms to two or more wireless communications, the multihop relay communication scheme of FIG. 1 may be of no use. Correspondingly, in the multihop relay broadband wireless communication system, frame structures are needed for data transmission when any one of the BS, the RS, and the MS conforms to a heterogeneous system.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for supporting various systems in a multihop relay broadband wireless communication system.

Another aspect of the present invention is to provide an apparatus and a method for servicing a mobile station compliant with a legacy system and a mobile station compliant with a new system in a multihop relay broadband wireless communication system.

Yet another aspect of the present invention is to provide an apparatus and a method for servicing a mobile station of a new system and a mobile station of a legacy system using a base station of the new system in a multihop relay broadband wireless communication system.

Still another aspect of the present invention is to provide an apparatus and a method for a base station of a new system to provide a relay service to a mobile station of a legacy system using a relay station of the legacy system in a multihop relay broadband wireless communication system.

A further aspect of the present invention is to provide an apparatus and a method for a base station of a new system to provide a relay service to a mobile station of the new system using a relay station of the new system in a multihop relay broadband wireless communication system.

A further aspect of the present invention is to provide frame structures for supporting various systems in a multihop relay broadband wireless communication system.

A further aspect of the present invention is to provide frame structures for simultaneously servicing a mobile station of a new system using a base station of the new system, servicing a mobile station of a legacy system, servicing a mobile station of the legacy system using a relay station of the legacy system, and servicing a mobile station of the new system using a relay station of the new system in a multihop relay broadband wireless communication system.

In accordance with an aspect of the present invention, a DownLink (DL) communication method of a Base Station (BS) in a multihop relay broadband wireless communication system, a DL period of the BS comprising a legacy zone for communicating with entities of a legacy system and a new zone for communicating with entities of a new system is provided. The method includes transmitting DL data to entities of the legacy system via the legacy zone, and transmitting DL data to entities of the new system via the new zone which follows the legacy zone in a time axis.

In accordance with another aspect of the present invention, an UpLink (UL) communication method of a BS in a multihop relay broadband wireless communication system, a UL period of the BS comprising a legacy zone for communicating with entities of a legacy system and a new zone for communicating with entities of a new system is provided. The method includes receiving UL data from entities of the legacy system via the legacy zone, and receiving UL data from entities of the new system via the new zone.

In accordance with yet another aspect of the present invention, a DL communication method of a new Relay Station (RS) in a multihop relay broadband wireless communication system, a DL period of the new RS comprising at least one of at least one new access zone for communicating with a new Mobile Station (MS) and a new relay zone for communicating with a BS according to a new system standard is provided. The method includes transmitting DL data to at least one new MS via the at least one new access zone, and receiving DL data destined for the new MS from the BS via the new relay zone which follows the at least one new access zone in a time axis.

In accordance with still another aspect of the present invention, a UL communication method of a new RS in a multihop relay broadband wireless communication system, a UL period of the new RS comprising at least one new access zone for communicating with a new MS and a new relay zone for communicating with a BS according to a new system standard is provided. The method includes receiving UL data from a new MS via the at least one new access zone, and transmitting the UL data from the new MS to the BS via the new relay zone which follows the at least one new access zone in a time axis.

In accordance with a further aspect of the present invention, a DL communication apparatus of a BS in a multihop relay broadband wireless communication system, a DL period of the BS comprising a legacy zone for communicating with entities of a legacy system and a new zone for communicating with entities of a new system is provided. The apparatus includes a mapper for mapping a DL data signal destined for the entities of the legacy system into the legacy zone, and for mapping a UL data signal destined for the entities of the new system into the new zone which follows the legacy zone in a time axis, and a transmitter for transmitting the DL data signals.

In accordance with a further aspect of the present invention, a UL communication apparatus of a BS in a multihop relay broadband wireless communication system, a UL period of the BS comprising a legacy zone for communicating with entities of a legacy system and a new zone for communicating with entities of a new system is provided. The apparatus includes a receiver for receiving UL data signals, and a demapper for extracting UL data signals from entities of the legacy system in the legacy zone, and for extracting UL data signals from entities of the new system in the new zone.

In accordance with a further aspect of the present invention, a communication apparatus of a new RS in a multihop relay broadband wireless communication system, a DL period of the new RS comprising at least one of a new access zone for communicating with a new MS and a new relay zone for communicating with a BS according to a new system standard is provided. The apparatus includes a mapper for mapping a DL data signal destined for at least one new MS into the at least one new access zone, and a demapper for extracting DL data received from the BS and destined for the new MS in the new relay zone which follows the at least one new access zone in a time axis.

In accordance with yet a further aspect of the present invention, a communication apparatus of a new RS in a multihop relay broadband wireless communication system, a UL period of the new RS comprising at least one new access zone for communicating with a new MS and a new relay zone for communicating with a BS according to a new system standard is provided. The apparatus includes a demapper for extracting a UL data signal from a new MS in the at least new access zone, and a demapper for mapping the UL data signal received from the new MS and destined for the BS into the new relay zone which follows the at least one new access zone in the time axis.

In accordance with still a further aspect of the present invention, a multihop relay broadband wireless communication system is provided. The system includes a BS for, in a DL period, transmitting DL signals to entities of a legacy system via a legacy zone for communicating with entities of the legacy system, and for transmitting DL signals to entities of a new system via a new zone for communicating with entities of the new system, the new zone following the legacy zone in a time axis, a legacy RS for receiving a DL signal from the BS via a legacy relay zone which occupies part of the same time zone as the legacy zone, and for transmitting a DL signal to at least one legacy MS via at least one legacy access zone which occupies all or part of another time zone excluding the legacy relay zone, and a new RS for receiving a DL signal from the BS via a new relay zone which occupies a rear end of the same time zone as the new zone in the time axis, and for transmitting a DL signal to at least one new MS via at least one new access zone which occupies all or part of another time zone excluding the new relay zone.

In accordance with a further aspect of the present invention, a multihop relay broadband wireless communication system is provided. The system includes a BS for, in a UL period, receiving UL signals from entities of a legacy system via a legacy zone for communicating with entities of the legacy system, and for receiving UL signals from entities of a new system via a new zone for communicating with entities of the new system, the new zone following the legacy zone in a time axis, a legacy RS for transmitting a UL signal to the BS via a legacy relay zone which occupies part of the same time zone as the legacy zone, and for receiving a UL signal from at least one legacy MS via at least one legacy access zone which occupies all or part of another time zone excluding the legacy relay zone, and a new RS for transmitting a UL signal to the BS via a new relay zone which occupies a rear end of the same time zone as the new zone in the time axis, and for receiving a UL signal from at least one new MS via at least one new access zone which occupies all or part of another time zone excluding the new relay zone.

In accordance with a further aspect of the present invention, a multihop relay broadband wireless communication system is provided. The system includes a BS for, in a UL period, receiving UL signals from entities of a legacy system via a legacy zone for communicating with entities of the legacy system, and for receiving UL signals from entities of a new system via a new zone for communicating with entities of the new system, the new zone multiplexed with the legacy zone in a frequency axis, a legacy RS for transmitting a UL signal to the BS via a legacy relay zone which occupies a rear end of a band of the legacy zone in the time axis, and for receiving a UL signal from at least one legacy MS via at least one legacy access zone which occupies all or part of another time zone excluding the legacy relay zone, and a new RS for transmitting a UL signal to the BS via a new relay zone which occupies a rear end of a band of the new zone in the time axis, and for receiving a UL signal from at least one new MS via at least one new access zone which occupies all or part of another time zone excluding the new relay zone.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will be more apparent from the following description taken in conjunction with the accompanying drawings, in which:

FIG. 1 illustrates a conventional Institute of Electrical and Electronics Engineers (IEEE) 802.16j wireless communication system and a frame structure;

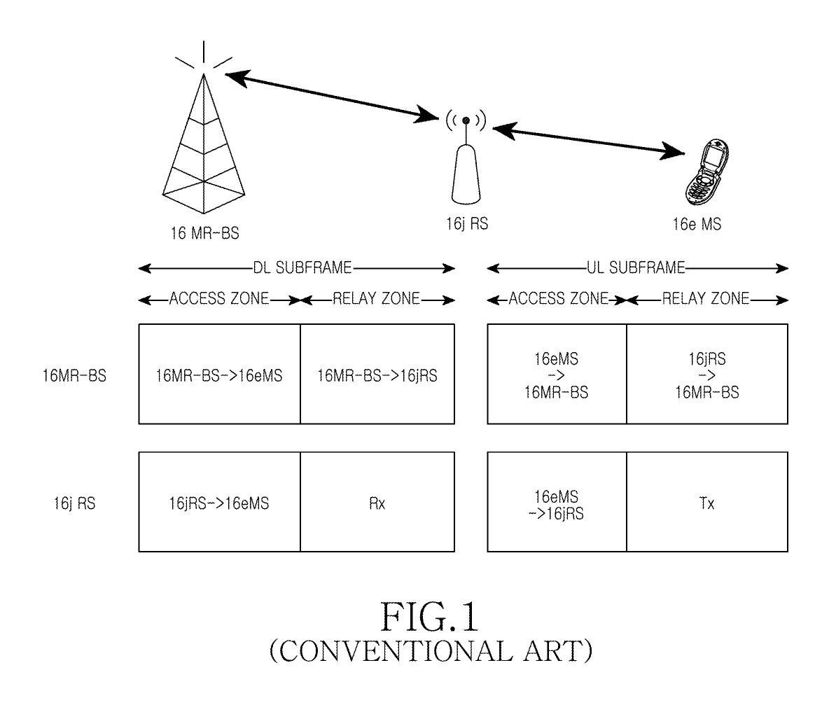

FIG. 2 illustrates a Relay Station (RS) and a Mobile Station (MS) compliant with a legacy system and an RS and an MS compliant with a new system in a multihop relay broadband wireless communication system according to an exemplary embodiment of the present invention;

FIG. 3 illustrates a DownLink (DL) period in the multihop relay broadband wireless communication system according to an exemplary embodiment of the present invention;

FIG. 4 illustrates an UpLink (UL) period in the multihop relay broadband wireless communication system according to an exemplary embodiment of the present invention;

FIG. 5 illustrates a UL period in the multihop relay broadband wireless communication system according to another exemplary embodiment of the present invention;

FIG. 6 illustrates a DL communication apparatus of a Base Station (BS) in a multihop relay broadband wireless communication system according to an exemplary embodiment of the present invention;

FIG. 7 illustrates a UL communication apparatus of the BS in a multihop relay broadband wireless communication system according to an exemplary embodiment of the present invention;

FIG. 8 illustrates an RS in a multihop relay broadband wireless communication system according to an exemplary embodiment of the present invention;

FIG. 9 illustrates a DL communication method of a BS in a multihop relay broadband wireless communication system according to an exemplary embodiment of the present invention;

FIG. 10 illustrates a UL communication method of a BS in a multihop relay broadband wireless communication system according to an exemplary embodiment of the present invention;

FIG. 11 illustrates a UL communication method of a BS in a multihop relay broadband wireless communication system according to another exemplary embodiment of the present invention;

FIG. 12 illustrates a DL communication method of an RS compliant with a legacy system in a multihop relay broadband wireless communication system according to an exemplary embodiment of the present invention;

FIG. 13 illustrates a DL communication method of an RS compliant with a legacy system in a multihop relay broadband wireless communication system according to another exemplary embodiment of the present invention;

FIG. 14 illustrates a UL communication method of an RS compliant with a legacy system in a multihop relay broadband wireless communication system according to an exemplary embodiment of the present invention;

FIG. 15 illustrates a DL communication method of an RS compliant with a new system in the multihop relay broadband wireless communication system according to an exemplary embodiment of the present invention;

FIG. 16 illustrates a UL communication method of an RS compliant with a new system in a multihop relay broadband wireless communication system according to an exemplary embodiment of the present invention; and

FIG. 17 illustrates a UL communication method of an RS compliant with a new system in the multihop relay broadband wireless communication system according to another exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide frame structures for supporting heterogeneous systems in a multihop relay broadband wireless communication system. In particular, the present invention provides frame structures for simultaneously supporting a Mobile Station (MS) of a new system using a Relay Station (RS) of the new system in the new wireless system, and an MS of a legacy system using an RS of the legacy system.

Herein, the multihop relay broadband wireless access communication system adopts, for example, an Orthogonal Frequency Division Multiplexing (OFDM) scheme or an Orthogonal Frequency Division Multiple Access (OFDMA) scheme. Using the OFDM/OFDMA scheme, the multihop relay broadband wireless access communication system may realize a high-speed data transmission by sending a physical channel signal using a plurality of subcarriers, and support mobility of the MS by means of a multi-cell structure.

While the broadband wireless access communication system is illustrated by way of example, the present invention is applicable to any cellular based wireless communication system based on a multihop relay.

To facilitate a better understanding of the present disclosure, an MS compliant with a legacy system is referred to as a legacy MS, an MS compliant with a new system is referred to as a new MS, a Base Station (BS) compliant with a new system is referred to as a new BS, an RS compliant with the legacy system is referred to as a legacy RS, and an RS compliant with the new system is referred to as a new RS. For example, the legacy MS may conform to the Institute of Electrical and Electronics Engineers (IEEE) 802.16e standard, the new MS may conform to the IEEE 802.16m standard, the new BS may conform to the IEEE 802.16m standard, the legacy RS may conform to the IEEE 802.16j standard, and the new RS may conform to the IEEE 802.16m standard.

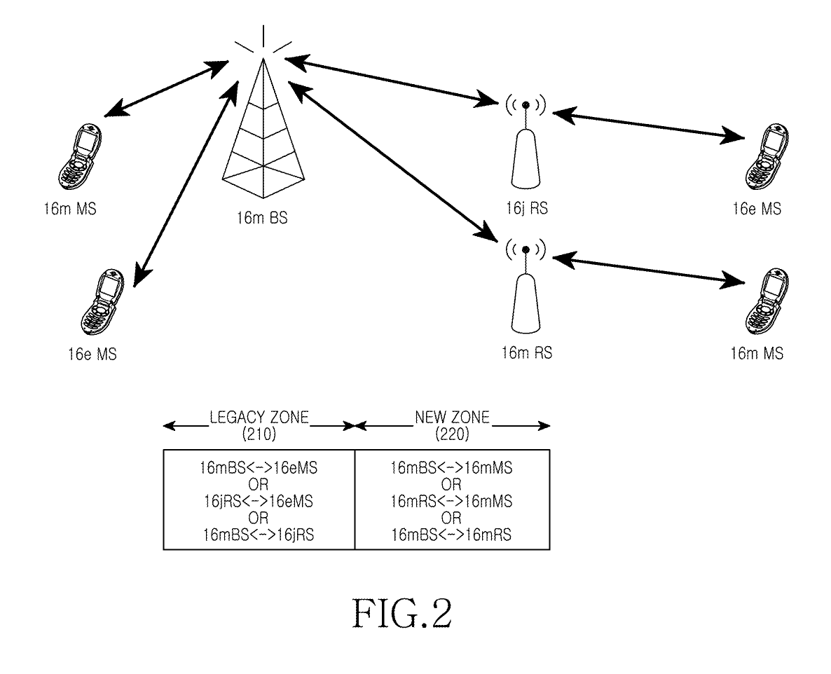

FIG. 2 illustrates a legacy RS, a legacy MS, a new RS, and a new MS in a multihop relay broadband wireless communication system, and a generalized frame structure according to an exemplary embodiment of the present invention.

Referring to FIG. 2, the new multihop relay broadband wireless communication system includes a BS (16m BS), a new MS (16m MS), and a new RS (16m RS). The BS (16m BS) provides the communication service to the new MS (16m MS) of the new broadband wireless communication system and a legacy MS (16e MS) of a legacy system. When the new MS (16m MS) travels out of the service coverage area of the BS, the BS (16m BS) may transmit and receive data of the new MS (16m MS) using a relay service of the new RS (16m RS). When the legacy MS (16e MS) of the legacy system gets out of the service coverage area of the BS (16m BS), data of the legacy MS (16e MS) may be transmitted using the relay service of the legacy RS (16j RS) of the legacy system. For doing so, communications between the BS (16m BS) and the legacy RS (16j RS) are permitted.

Communications between the entities in the heterogeneous system are conducted in two zones based on the data transmission and reception with the entity of the legacy system. One zone is a legacy zone 210 including at least one of a communication zone between the legacy MS (16e MS) of the legacy system and the BS (16m BS) of the new system, a communication zone between the legacy RS (16j RS) of the legacy system and the legacy MS (16e MS) of the legacy system, and a communication zone between the legacy RS (16j RS) of the legacy system and the BS (16m BS) of the new system. The other zone is a new zone 220 including at least one of a communication zone between the BS (16m BS) of the new system and the new MS (16m MS) of the new system, a communication zone between the new RS (16m RS) of the new system and the new MS (16m MS) of the new system, and a communication zone between the BS (16m BS) of the new system and the new RS (16m RS) of the new system.

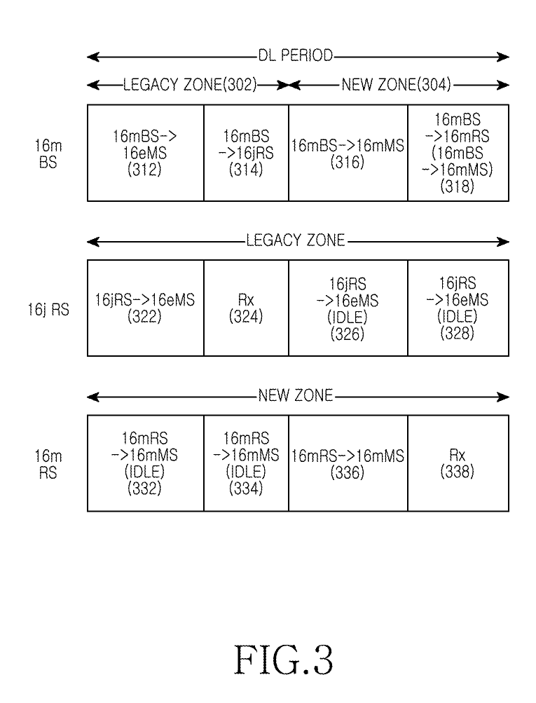

Now, examples of a frame structure for supporting the wireless communication system of FIG. 2 are explained by referring to FIGS. 3-5.

FIG. 3 illustrates a DownLink (DL) period in the multihop relay broadband wireless communication system according to an exemplary embodiment of the present invention.

Referring to FIG. 3, the DL period of the BS (16m BS) includes a legacy zone 302 for communication with an entity of the legacy system, and a new zone 304 for communication with an entity of the same wireless communication system as the BS. The legacy zone 302 of the DL is divided into an access zone 312 and a relay zone 314. In the access zone 312, the BS (16m BS) transmits data to the legacy MS (16e MS) compliant with the legacy system. In the relay zone 314, the BS (16m BS) transmits DL data used to provide the relay service to the legacy MS (16e MS), to the legacy RS (16j RS) compliant with the legacy system.

The new zone 304 of the DL is divided into an access zone 316 and a relay zone 318. In the access zone 316, the BS (16m BS) transmits DL data to the new MS (16m MS) compliant with the same system. In the relay zone 318, the BS transmits DL data used to provide the relay service to the new MS (16m MS), to the new RS (16m RS) compliant with the same system. If necessary, the relay zone 318 of the new zone 304 may be used to transfer DL data from the BS (16m BS) to the new MS (16m MS), in addition to the DL data transmission to the new RS (16m RS).

The DL period of the legacy RS (16j RS) compliant with the legacy wireless communication system includes only a legacy zone. The legacy zone is divided into an access zone 322 and a relay zone 324. In the access zone 322, the legacy RS (16j RS) transmits data to the legacy MS (16e MS) compliant with the legacy wireless communication system. In the relay zone 324, the DL data sent from the BS (16m BS) to the legacy MS (16e MS) and the DL data used to provide the relay service to the legacy MS (16e MS) are received.

Meanwhile, in the new zone 304 of the DL period of the BS, the legacy RS (16j RS) may transmit DL data to the legacy MS (16e MS). The legacy RS may transmit the DL data in both of the access zone 316 and the relay zone 318 of the new zone 304 of the DL period of the BS, or in only one of the two zones 326 and 328 corresponding to the new zone 304. Alternatively, in the zones 326 and 328 corresponding to the new zone 304 of the DL period of the BS, the legacy RS (16j RS) may not send the DL data to the legacy MS (16e MS). That is, the two zones 326 and 328 corresponding to the new zone 304 may be used as the access zone or as an idle zone. The DL period of the legacy RS (16j RS) may further include a gap (not shown) for changing the transmission and the reception of the RS when the access zone 322 and the relay zone 324 are switched over.

The DL period of the new RS (16m RS) compliant with the new system includes only a new zone. The new zone is divided into an access zone 336 and a relay zone 338. In the access zone 336, the new RS (16m RS) transmits data to the new MS (16m MS) compliant with the new system. In the relay zone 338, the DL data sent from the BS (16m BS) to the new MS (16m MS) and the DL data used to provide the relay service to the new MS (16m MS) are received.

The new RS (16m RS) may transmit the DL data to the new MS (16m MS) in the legacy zone 302 of the DL period of the BS. The new RS may transmit the DL data in both or one of the two zones 332 and 334 corresponding to the legacy zone 302 of the DL period of the BS. Alternatively, the new RS (16m RS) may not send the DL data to the new MS (16m MS) in the two zones 332 and 334 corresponding to the legacy zone 302 of the DL period of the BS. That is, the two zones 332 and 334 corresponding to the legacy zone 302 may be used as the access zone or as the idle zone respectively.

Herein, the access zone of the DL period of the new RS (16m RS) may equal the access zone 312 of the legacy zone 302 of the DL period of the BS, the relay zone 314 of the legacy zone 302 of the DL period of the BS, and the relay zone 316 of the new zone 304 of the DL period of the BS. Namely, the new RS is able to transmit the DL data to the new MS (16m MS) using at least one of the three zones 332, 334, and 336. Of the three zones 332 334 and 336, the zone not used as the access zone is the idle zone. The DL period of the new RS (16m RS) may further include a gap (not shown) for changing the transmission and the reception of the RS when the access zone 336 and the relay zone 338 are switched over.

As the relay zone 338 of the new RS occupies the rear end in the time axis of the DL period as illustrated in FIG. 3, only a single gap is enough to switch the transmission and the reception of the new RS. When the relay zone 338 of the new RS occupies a part other than the rear end in the time axis of the DL period and an access zone follows the relay zone 338, the new RS switches the transmission and the reception more than two times within the DL period. In this situation, the gap for the transmission and reception transition results in a waste of resources.

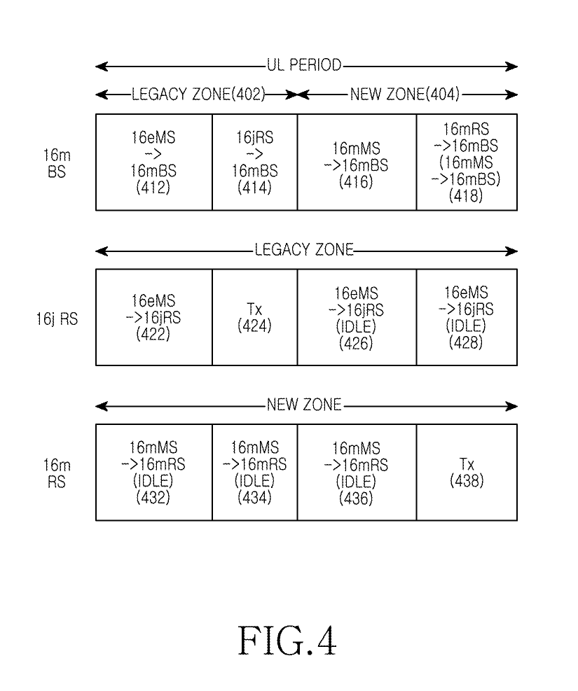

FIG. 4 illustrates an UpLink (UL) period in the multihop relay broadband wireless communication system according to an exemplary embodiment of the present invention.

Referring to FIG. 4, the UL period of the BS (16m BS) includes a legacy zone 402 for communication with an entity of the legacy wireless communication system, and a new zone 404 for communication with an entity of the same wireless communication system as the BS. The UL legacy zone 402 is divided into an access zone 412 and a relay zone 414. In the access zone 412, the legacy MS (16e MS) compliant with the legacy wireless communication system transmits UL data to the BS (16m BS). In the relay zone 414, the BS receives UL data of the legacy MS (16e MS) from the legacy RS (16j RS) compliant with the legacy wireless communication system, and UL data used to provide the relay service to the legacy MS (16e MS).

The new zone 404 of the UL is divided into an access zone 416 and a relay zone 418. Via the access zone 414, the BS (16m BS) receives UL data of the new MS (16m MS) compliant with the same system. Via the relay zone 418, the BS receives UL data from the new RS (16m RS) compliant with the same system. If necessary, the relay zone 418 of the new zone 404 may be used to receive the UL data from the new MS (16m MS), in addition to the UL data reception from the new RS (16m RS).

The UL period of the legacy RS (16j RS) compliant with the legacy wireless communication system includes only a legacy zone. The legacy zone is divided into an access zone 422 and a relay zone 424. In the access zone 422, the legacy RS (16j RS) receives data from the legacy MS (16e MS) compliant with the legacy wireless communication system. In the relay zone 424, the legacy RS sends the UL data received from the legacy MS (16e MS) and the UL data used to provide the relay service to the legacy MS (16e MS), to the BS (16m BS).

In the new zone 404 of the UL period of the BS, the legacy RS (16j RS) may receive UL data from the legacy MS (16e MS). The legacy RS may receive the UL data in both or one of the two zones 426 and 428 corresponding to the new zone 404 of the UL period of the BS. Alternatively, in the two zones 426 and 428 corresponding to the new zone 404 of the UL period of the BS, the legacy RS (16j RS) may not receive the UL data from the legacy MS (16e MS). In other words, the two zones 426 and 428 corresponding to the new zone 404 may be used as the access zone or the idle zone respectively.

The UL period of the legacy RS (16j RS) may further include a gap (not shown) for changing the transmission and the reception of the RS when the access zone 422 and the relay zone 424 are switched over.

The UL period of the new RS (16m RS) compliant with the new system includes only a new zone. The new zone is divided into an access zone 436 and a relay zone 438. Via the access zone 436, the new RS (16m RS) receives UL data from the new MS (16m MS) compliant with the new system. Via the relay zone 438, the new RS sends UL data from the new MS (16m MS) and UL data used to provide the relay service to the new MS (16m MS), to the BS (16m BS).

Herein, the access zone of the UL period of the new RS (16m RS) may equal the access zone 412 of the legacy zone 402 of the UL period of the BS, the relay zone 414 of the legacy zone 402 of the UL period of the BS, and the access zone 416 of the new zone 404 of the UL period of the BS. The RS may receive the UL data of the new MS (16m MS) using at least one of the three zones 432, 434, and 436. Of the three zones 432, 434, and 436, the zone not used as the access zone is the idle zone. The UL period of the new RS (16m RS) may further include a gap (not shown) for the transition between the transmission and the reception of the RS when the access zone 436 and the relay zone 438 are switched over.

As the access zone 438 of the new RS occupies the rear end in the time axis of the UL period as illustrated in FIG. 4, only a single gap is enough to switch the transmission and the reception of the new RS. When the access zone 438 of the new RS occupies a part other than the rear end in the time axis of the UL period and a relay zone follows the access zone 438, the new RS needs to switch the transmission and the reception more than two times within the UL period. In this situation, the gap for the transmission and reception transition causes a waste of resources.

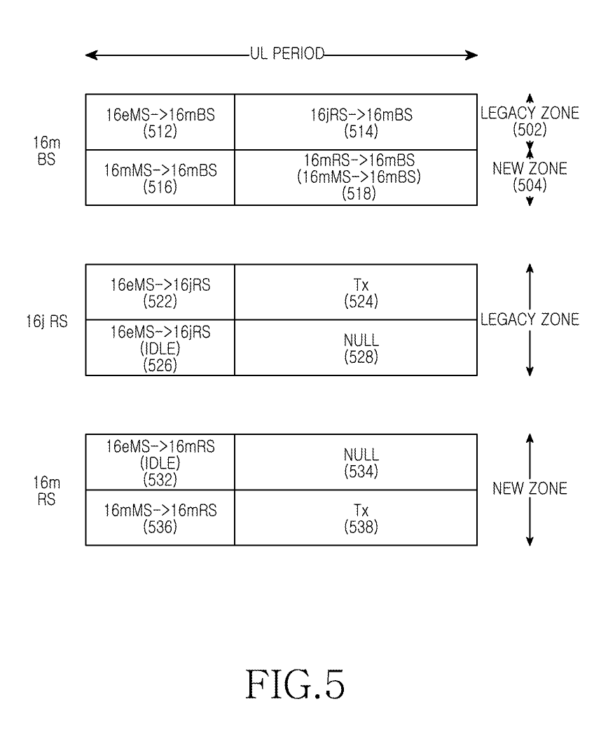

In FIG. 4, the legacy zone, the new zone, the access zone, and the relay zone of the UL period are constituted by dividing the time domain of the UL period. In various exemplary embodiments, the legacy zone, the new zone, the access zone, and the relay zone may be divided in the frequency domain. In this case, an example of the frame structure is described by referring to FIG. 5.

FIG. 5 illustrates a UL period in the multihop relay broadband wireless communication system according to another exemplary embodiment of the present invention.

Referring to FIG. 5, the UL period of the BS (16m BS) includes a legacy zone 502 for communication with the entity of the legacy wireless communication system and a new zone 504 for communication with the entity of the same wireless communication system as the BS. The legacy zone 502 and the new zone 504 divide and use resources in the frequency domain. The resource division in the frequency domain indicates that a portion or all of the subcarriers are allocated to the legacy zone 502 or the new zone 504, or some subcarriers are allocated to the MS compliant with the new system and others are allocated to the MS compliant with the legacy system. The UL legacy zone 502 is divided into an access zone 512 and a relay zone 514. The access zone 512 and the relay zone 514 may divide and use the time domain resources. Via the access zone 512, the legacy MS (16e MS) compliant with the legacy wireless communication system transmits UL data to the BS (16m BS). Via the relay zone 514, the BS (16m BS) receives UL data of the legacy MS (16e MS) from the legacy RS (16j RS) compliant with the legacy wireless communication system and UL data used to provide the relay service to the legacy MS (16e MS).

The new zone 504 of the UL is divided into an access zone 516 and a relay zone 518. The access zone 516 and the relay zone 518 divide and utilize the time domain resources. Via the access zone 516, the BS receives UL data from the new MS (16m MS) compliant with the same system. Via the relay zone 518, the BS receives UL data from the new RS (16m RS) compliant with the same system. If necessary, the BS (16m BS) may receive the UL data from the new MS (16m MS) via the relay zone 518.

The UL period of the legacy RS (16j RS) compliant with the legacy wireless communication system includes only a legacy zone. The legacy zone is divided into an access zone 522 and a relay zone 524. In the access zone 522, the legacy RS (16j RS) receives data from the legacy MS (16e MS) compliant with the legacy wireless communication system. In the relay zone 524, the legacy RS transmits UL data from the legacy MS (16e MS) and UL data used to provide the relay service to the legacy MS (16e MS), to the BS (16m BS).

The new zone 504 of the UL period of the BS may be used as the access zone for the legacy RS (16j RS) to receive the UL data of the legacy MS (16e MS). When the new zone 504 of the UL period of the BS utilizes the same time zone as the zone via which the legacy RS (16j RS) transmits the UL data to the BS, the zone 528 corresponding to the new zone 504 may not be used for the legacy RS (16j RS) to receive the UL data from the legacy MS (16e MS). That is, the zone 528 corresponding to the new relay zone 518 is a null zone. When the zone corresponding to the new zone 504 does not use the same time zone as the relay zone 524 of the legacy RS (16j RS), the new zone 504 may or may not be used to transmit the UL data of the legacy MS (16e MS). In other words, the zone 526 corresponding to the new access zone 516 may be used as the access zone for the legacy RS (16j RS) to receive the UL data of the legacy MS (16e MS), or as the idle zone. The UL period of the legacy RS (16j RS) may further include a gap (not shown) for changing the transmission and the reception of the RS when the access zone 522 and the relay zone 524 are switched over.

The UL period of the new RS (16m RS) compliant with the new system includes only a new zone. The new zone is divided into an access zone 536 and a relay zone 538. Via the access zone 536, the new RS (16m RS) receives data from the new MS (16m MS) compliant with the same wireless communication system. Via the relay zone 538, the new RS transmits UL from the new MS (16m MS) and UL data used to provide the relay service to the new MS (16m MS), to the BS (16m BS).

The zone corresponding to the legacy zone 502 of the UL period of the BS may be used as the access zone for the new RS (16m RS) to receive the UL data of the new MS (16m MS). When the legacy zone 502 of the UL period of the BS uses the same time zone as the relay zone 538 of the new RS (16m RS), the zone corresponding to the legacy zone 502 may not be used for the new RS (16m RS) to receive the UL data from the new MS (16m MS). Namely, the zone 534 corresponding to the legacy relay zone 514 is a null zone. When the zone corresponding to the legacy zone 502 does not use the same time region as the relay zone 538 of the new RS (16m RS), the legacy zone 502 may or may not be used to transmit the UL data of the new MS (16m MS). The zone 532 corresponding to the legacy access zone 512 may be used as the access zone for the new RS (16m RS) to receive the UL data of the new MS (16m MS), or as the idle zone. The UL period of the new RS (16m RS) may further include a gap for changing the transmission and the reception of the RS when the access zone 536 and the relay zone 538 are switched over.

So far, the UL and DL period structures of the BS, the RS compliant with the new system, and the RS compliant with the legacy system have been explained to support the coexistence of the BS, MS, and the RS of the new system and the RS and the MS of the legacy system in FIGS. 3, 4 and 5. When exemplary embodiments of the present system conduct both of the UL communication and the DL communication, the frames may be constituted to correspond to all of the number of the cases by combining the UL period structure and the DL period structures. It should be appreciated that the present invention is equally applicable to those frames.

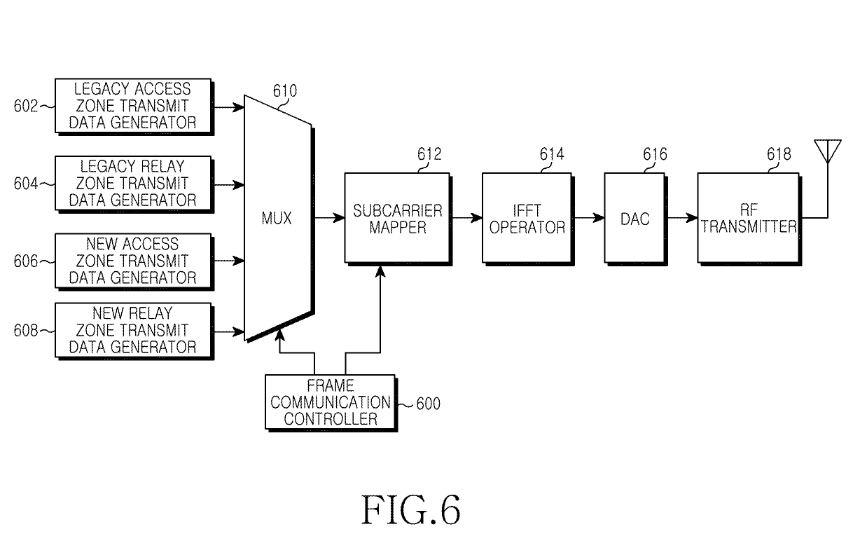

Now, structures of the BS, the new RS, and the legacy RS for communicating with the above-mentioned frames are described in detail by referring to FIGS. 6-8.

FIG. 6 is a block diagram of a DL communication apparatus of the BS in a multihop relay broadband wireless communication system according to an exemplary embodiment of the present invention.

Referring to FIG. 6, the DL communication apparatus of the BS includes a frame communication controller 600, a legacy access zone transmit data generator 602, a legacy relay zone transmit data generator 604, a new access zone transmit data generator 606, a new relay zone transmit data generator 608, a multiplexer (MUX) 610, a subcarrier mapper 612, an Inverse Fast Fourier Transform (IFFT) operator 614, a Digital to Analog Converter (DAC) 616, and a Radio Frequency (RF) transmitter 618.

The legacy access zone transmit data generator 602 generates data to be sent via the legacy access zone. That is, the legacy access zone transmit data generator 602 generates the DL data to be sent to the legacy MS. The legacy relay zone transmit data generator 604 generates data to be sent via the legacy relay zone, that is, the DL data to be transmitted to the legacy RS. The new access zone transmit data generator 606 generates data to be sent via the new access zone, that is, the DL data to be transmitted to the new MS. The new relay zone transmit data generator 608 generates data to be sent via the new relay zone, that is, the DL data to be transmitted to the new RS. Herein, it is assumed that the generators 602 through 608 each include a processor (e.g., a Media Access Control (MAC) processor) for processing the signaling of the corresponding standard and an encoder and modulator for encoding and modulating the transmit packet.

The frame communication controller 600 controls the MUX 610 and the subcarrier mapper 612 for the DL communication with the defined DL period structure. Under the control of the controller 600, the MUX 610 selects one of the outputs of the generators 602 through 608 and provides the selected output to the subcarrier mapper 612. For example, in the legacy access zone of the DL period, the MUX 610 provides the transmit data from the legacy access zone transmit data generator 602 to the subcarrier mapper 612. In the legacy relay zone, the MUX 610 provides the transmit data from the legacy relay zone transmit data generator 604 to the subcarrier mapper 612. In the new access zone, the MUX 610 provides the transmit data from the new access zone transmit data generator 606 to the subcarrier mapper 612. In the new relay zone, the MUX 610 provides the transmit data from the new relay zone transmit data generator 608 to the subcarrier mapper 612. Herein, it is assumed that the legacy access zone, the legacy relay zone, the new access zone, and the new relay zone are distinguished in the time division manner as illustrated in FIGS. 3 and 4. However, the legacy access zone, the legacy relay zone, the new access zone, and the new relay zone may be distinguished in the frequency division manner as illustrated in FIG. 5. Note that the time order of the new access zone and the new relay zone may be altered.

The subcarrier mapper 612 permutates the transmit data output from the MUX 610 according to a permutation scheme (or a subcarrier allocation scheme) of the corresponding standard and maps the permutated data to the subcarriers under the control of the controller 600. The IFFT operator 614 outputs sample data by IFFT-processing the subcarrier-mapped data output from the subcarrier mapper 612. In doing so, the IFFT operator 614 generates OFDM symbols by inserting a guard interval (e.g., Cyclic Prefix (CP)) into the sample data. The DAC 616 converts the sample data output from the IFFT operator 614 into an analog signal. The RF transmitter 618 converts the baseband signal output from the DAC 616 into an RF signal and transmits the RF signal via an antenna.

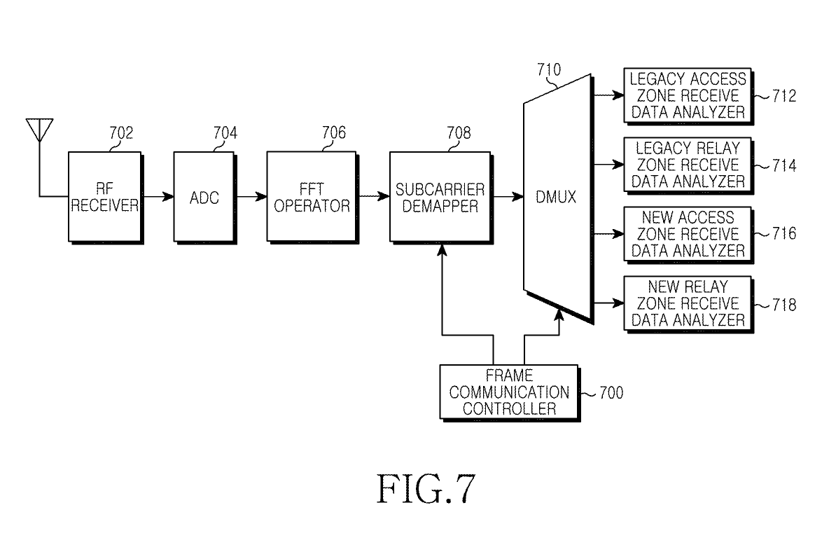

FIG. 7 is a block diagram of a UL communication apparatus of a BS in the multihop relay broadband wireless communication system according to an exemplary embodiment of the present invention.

Referring to FIG. 7, the UL communication apparatus of the BS of includes a frame communication controller 700, an RF receiver 702, an Analog to Digital Converter (ADC) 704, a FFT operator 706, a subcarrier demapper 708, a de-MUX (DMUX) 710, a legacy access zone receive data analyzer 712, a legacy relay zone receive data analyzer 714, a new access zone receive data analyzer 716, and a new relay zone receive data analyzer 718.

The RF receiver 702 converts the RF signal received via an antenna into a baseband signal. The ADC 704 converts the baseband analog signal output from the RF receiver 702 into digital sample data. The FFT operator 706 removes the guard interval from the sample data output from the ADC 704 and FFT-processes the sample data without the guard interval.

The frame communication controller 700 controls the subcarrier demapper 708 and the DMUX 710 for the UL communication according to the defined UL period structure. The subcarrier demapper 708 classifies the data output from the FFT operator 706 on the zone basis and rearranges the data of the zones according to the permutation scheme of the corresponding zone under the control of the controller 700. In doing so, the zones may be distinguished in the time division manner as illustrated in FIGS. 3 and 4, or in the frequency division manner as shown in FIG. 5. Note that the time order of the new access zone and the new relay zone may be altered. Under the control of the controller 700, the DMUX 710 selects the legacy access zone receive data among the data output from the subcarrier demapper 708 and provides the selected data to the analyzer 712, selects and provides the legacy relay zone receive data to the analyzer 714, and selects and provides the new zone receive data to the analyzer 716.

The legacy access zone receive data analyzer 712 demodulates and decodes the legacy access zone receive data output from the DMUX 710 and analyzes the decoded data. That is, the legacy access zone receive data analyzer 712 analyzes the UL data received from the legacy MS. The legacy relay zone receive data analyzer 714 demodulates and decodes the legacy relay zone receive data output from the DMUX 710 and analyzes the decoded data. That is, the legacy relay zone receive data analyzer 714 analyzes the UL data received from the legacy RS. The new access zone receive data analyzer 716 demodulates and decodes the new access zone receive data output from the DMUX 710 and analyzes the decoded data. That is, the new access zone receive data analyzer 716 analyzes the UL data received from the new MS. The new relay zone receive data analyzer 718 demodulates and decodes the new relay zone receive data output from the DMUX 710 and analyzes the decoded data. That is, the new relay zone receive data analyzer 718 analyzes the UL data received from the new RS. Herein, it is assumed that the analyzers 712 through 718 each include a processor (e.g., MAC processor) for processing the signaling of the corresponding standard, and a demodulator and decoder for recovering the receive packet.

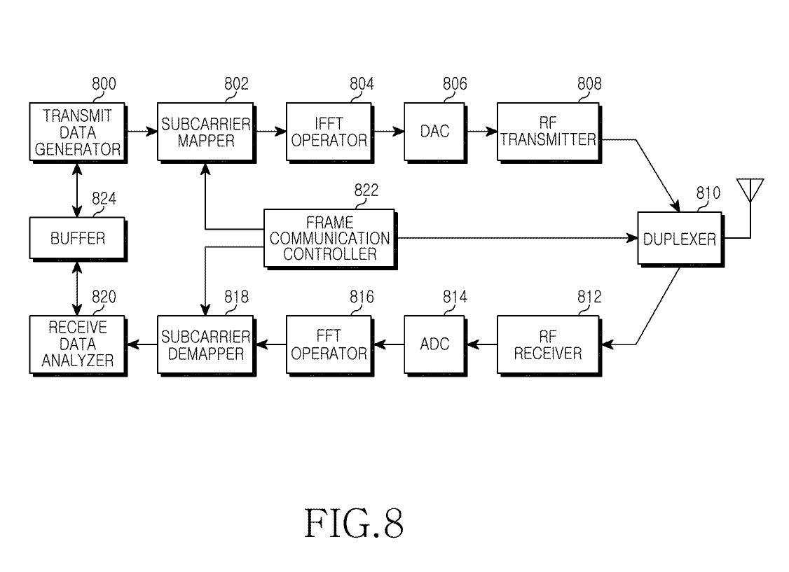

FIG. 8 is a block diagram of an RS in a multihop relay broadband wireless communication system according to an exemplary embodiment of the present invention. Herein, the RS represents both of the legacy RS and the new RS.

Referring to FIG. 8, the RS includes a transmit data generator 800, a subcarrier mapper 802, an IFFT operator 804, a DAC 806, an RF transmitter 808, a duplexer 810, an RF receiver 812, an ADC 814, an FFT operator 816, a subcarrier demapper 818, a receive data analyzer 820, a frame communication controller 822, and a buffer 824.

The buffer 824 temporarily stores the UL data and the DL data to be relayed. For example, the buffer 824 temporarily stores the DL data from the BS before it is relayed to the legacy MS, and temporarily stores the UL data from the MS before it is relayed to the BS. When the RS is the legacy RS, the buffer 824 temporarily stores the UL data from the legacy MS. When the RS is the new RS, the buffer 824 temporarily stores the UL data from the new MS.

The transmit data generator 800 generates data to be sent to the legacy MS or the new BS using the data output from the buffer 824. When the RS is the legacy RS, the transmit data generator 800 includes a processor for processing the signaling of the legacy standard, and an encoder and modulator for encoding and modulating the transmit packet. When the RS is the new RS, the transmit data generator 800 includes a processor for processing the signaling of the new standard, and an encoder and modulator for encoding and modulating the transmit packet.

The frame communication controller 822 controls the subcarrier mapper 802, the subcarrier demapper 818, and the duplexer 810 for the DL communication and the UL communication with the defined frame structure. The subcarrier mapper 802 permutates the transmit data output from the transmit data generator 800 according to the permutation scheme (or the subcarrier allocation scheme) of the corresponding standard and maps the permutated data to subcarriers under the control of the controller 822. Depending on the defined frame structure, the transmit data may be mapped to the whole or partial frequency area. For example, in the DL communication, the subcarrier mapper 802 may map the data to be sent to the MS via the access zone to the whole frequency domain as shown in FIG. 3. In the UL communication, the subcarrier mapper 802 may map the data to be sent to the BS via the relay zone to the whole frequency domain as shown in FIG. 4, or map the data to be sent to the new BS via the relay zone to the partial frequency domain as shown in FIG. 5.

The IFFT operator 804 produces sample data by IFFT-processing the data mapped to the subcarriers at the subcarrier mapper 802. The IFFT operator 804 generates OFDM symbols by inserting the guard interval (e.g., CP) into the sample data. The DAC 806 converts the sample data output from the IFFT operator 804 into an analog signal. The RF transmitter 808 converts the baseband signal output from the DAC 806 into an RF signal and provides the RF signal to the duplexer 810.

The duplexer 810 transmits the transmit signal output from the RF transmitter 808 via an antenna, and provides a signal received via the antenna to the RF receiver 812. The duplexer 810 switches the transmission and the reception under the control of the controller 822.

The RF receiver 812 converts the RF signal output from the duplexer 810 to the baseband signal. The ADC 814 converts the baseband analog signal output from the RF receiver 812 into digital sample data. The FFT operator 816 removes the guard interval from the sample data output from the ADC 814 and FFT-processes the sample data with the guard interval removed.

The subcarrier demapper 818 rearranges the data output from the FFT operator 816 according to the permutation scheme of the corresponding standard and extracts the receive data to be decoded, under the control of the controller 822. Depending on the frame structure, the receive data may be received in the whole or partial frequency domain. For example, in the DL communication, the data from the BS may be received through the whole frequency domain as shown in FIG. 3. In the UL communication, the data from the MS may be received via the access zone in the whole frequency domain as shown in FIG. 4, or the data from the legacy MS may be received via the access zone in the whole or partial frequency band as shown in FIG. 5.

The receive data analyzer 820 recovers the receive data output from the subcarrier demapper 818 and stores the restored data to the buffer 824 for the relay transmission. Herein, the receive data analyzer 820 is assumed to include a processor for processing the signaling of the legacy standard and a demodulator and decoder for restoring the receive packet.

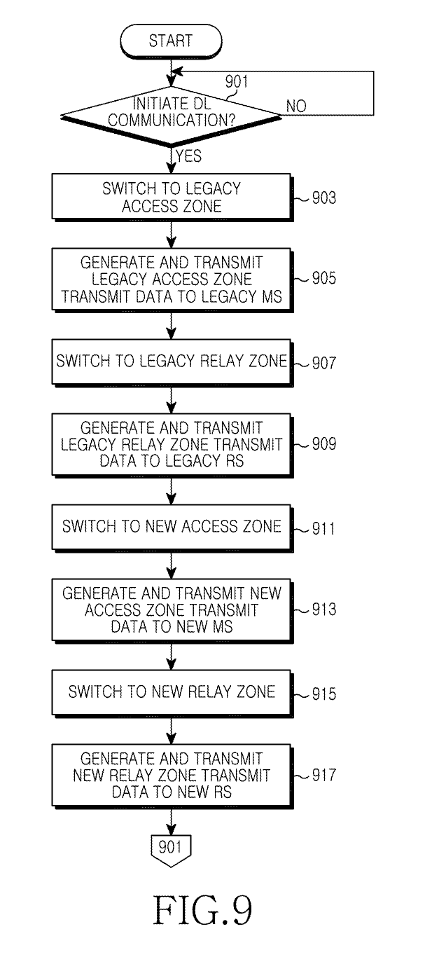

The operations of the BS, the new RS, and the legacy RS for communicating with the frame structure stated above are described in detail below by referring to FIGS. 9-17.

FIG. 9 is a flowchart outlining a DL communication method of a BS in a multihop relay broadband wireless communication system according to an exemplary embodiment of the present invention, that is, the DL communication method of the BS with the frame structure illustrated in FIG. 3.

In step 901, the BS determines whether the DL communication is initiated.

When the DL communication commences, the BS switches to the legacy access zone in step 903. That is, the BS prepares for the legacy access zone DL communication. For example, the preparation includes the transition of the transmission and the reception, the permutation setup change, and so on.

After switching to the legacy access zone, the BS generates and transmits the legacy access zone transmit data to the legacy MS by mapping the generated transmit data to the legacy access zone in step 905.

When the legacy access zone communication is completed, the BS switches to the legacy relay zone in step 907. That is, the BS prepares for the legacy relay zone DL communication.

In step 909, the BS generates and transmits the legacy relay zone transmit data to the legacy RS by mapping the generated transmit data to the legacy relay zone.

When the legacy relay zone communication is completed, the BS switches to the new access zone in step 911. That is, the BS prepares for the new access zone DL communication.

In step 913, the BS generates and transmits the new access zone transmit data to the new MS by mapping the generated transmit data to the new access zone.

When the new access zone communication is completed, the BS switches to the new relay zone in step 915. That is, the BS prepares for the new relay zone DL communication.

In step 917, the BS generates and transmits the new relay zone transmit data to the new RS by mapping the generated transmit data to the new relay zone. When the new relay zone communication is finished, the BS returns to step 901 to determine whether the next DL communication is initiated.

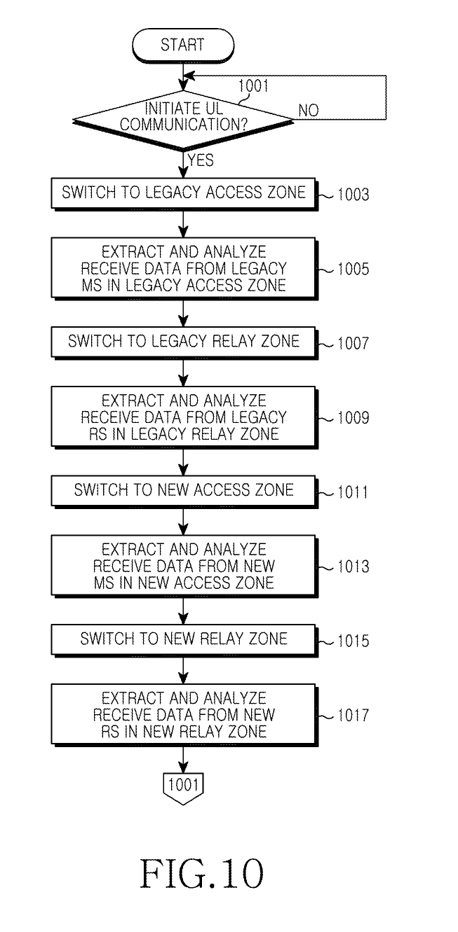

FIG. 10 is a flowchart outlining a UL communication method of a BS in a multihop relay broadband wireless communication system according to an exemplary embodiment of the present invention, that is, the UL communication method of the BS according to the frame structure illustrated in FIG. 4.

In step 1001, the BS determines whether the UL communication is initiated.

When the UL communication commences, the BS switches to the legacy access zone in step 1003. That is, the BS prepares for the legacy access zone UL communication. For example, the preparation includes the transition between the transmission and the reception, the permutation setup change, and so on.

In step 1005, the BS extracts and analyzes the receive data from the legacy MS in the legacy access zone by demodulating and decoding the extracted receive data.

When the legacy access zone communication finishes, the BS switches to the legacy relay zone in step 1007. That is, the BS prepares for the legacy relay zone UL communication.

In step 1009, the BS extracts and analyzes the receive data from the legacy RS in the legacy relay zone by demodulating and decoding the extracted receive data.

When the legacy relay zone communication finishes, the BS switches to the new access zone in step 1011. That is, the BS prepares for the new access zone UL communication.

In step 1013, the BS extracts and analyzes the receive data from the new MS in the new access zone by demodulating and decoding the extracted receive data.

When the new access zone communication finishes, the BS switches to the new relay zone in step 1015. That is, the BS prepares for the new relay zone UL communication.

In step 1017, the BS extracts and analyzes the receive data from the new RS in the new relay zone by demodulating and decoding the extracted receive data. When the new relay zone communication finishes, the BS goes back to step 1001 to examine whether the next UL communication is initiated.

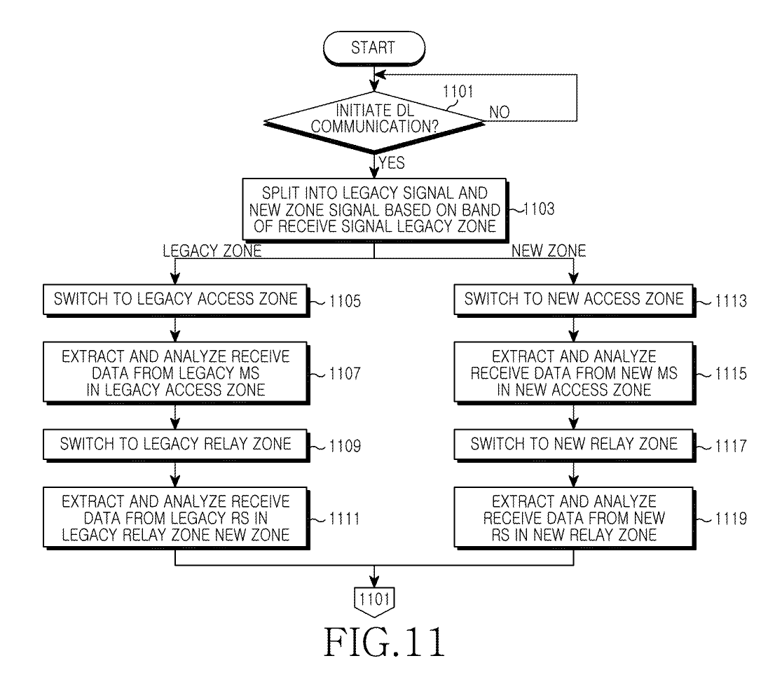

FIG. 11 is a flowchart of a UL communication method of a BS in a multihop relay broadband wireless communication system according to another exemplary embodiment of the present invention, that is, the UL communication method of the BS according to the frame structure illustrated in FIG. 5.

In step 1101, the BS determines whether the UL communication is initiated.

When the UL communication commences, the BS divides the received signal into the legacy zone signal and the new zone signal based on the frequency division scheme in step 1103. Next, the BS processes the legacy zone signal and the new zone signal respectively.

For the legacy zone signal processing, the BS switches to the legacy access zone in step 1105. That is, the BS prepares for the legacy access zone UL communication. For example, the preparation includes the transition between the transmission and the reception, the permutation setup change, and so on.

In step 1107, the BS extracts the legacy access zone receive data from the separated legacy zone signal, that is, extracts the receive data from the legacy MS, and analyzes the extracted receive data by demodulating and decoding the data.

When the legacy access zone communication finishes, the BS switches to the legacy relay zone in step 1109. That is, the BS prepares for the legacy relay zone UL communication.

In step 1111, the BS extracts the legacy relay zone receive data from the separated legacy zone signal, that is, extracts the receive data from the legacy RS, and analyzes the extracted receive data by demodulating and decoding the data. When the legacy relay zone communication finishes, the BS returns to step 1101 to examine whether the next UL communication is initiated.

For the new zone signal processing, the BS switches to the new access zone in step 1113. That is, the BS prepares for the new access zone UL communication. For example, the preparation includes the transition between the transmission and the reception, the permutation setup change, and so on.

In step 1115, the BS extracts the new access zone receive data from the separated new zone signal, that is, the receive data from the new MS, and analyzes the extracted receive data by demodulating and decoding the data.

When the new access zone communication is finished, the BS switches to the new relay zone in step 1117. That is, the BS prepares for the new relay zone UL communication.

In step 1119, the BS extracts the new relay zone receive data from the separated new zone signal, that is, the receive data from the new RS, and analyzes the extracted receive data by demodulating and decoding the data. When the new relay zone communication finishes, the BS returns to step 1101 to examine whether the next UL communication is initiated.

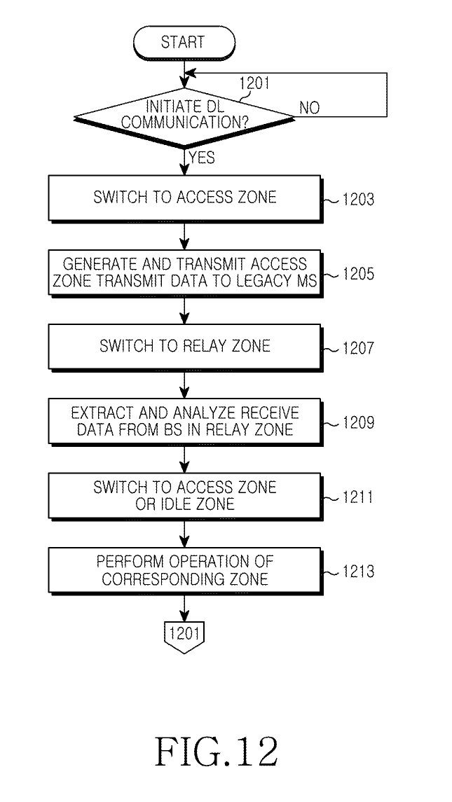

FIG. 12 is a flowchart outlining a DL communication method of an RS of a legacy system in a multihop relay broadband wireless communication system according to an exemplary embodiment of the present invention, that is, the DL communication method of the legacy RS according to the frame structure illustrated in FIG. 3.

In step 1201, the legacy RS determines whether the DL communication is initiated.

When the DL communication commences, the legacy RS switches to the access zone in step 1203. That is, the legacy RS prepares for the access zone DL communication. For example, the preparation includes the transition between the transmission and the reception, the permutation setup change, and so on.

In step 1205, the legacy RS generates the access zone transmit data and relays the generated transmit data to the legacy MS by mapping the transmit data to the access zone.

When the access zone communication ends, the legacy RS switches to the relay zone in step 1207. That is, the legacy RS prepares for the relay zone DL communication.

In step 1209, the legacy RS extracts the receive data of the BS in the relay zone and analyzes the receive data by demodulating and decoding the extracted receive data.

When the relay zone communication is finished, the legacy RS switches to the access zone or the idle zone in step 1211.

Next, the legacy RS performs the operation of the corresponding zone in step 1213 and goes back to step 1201 to examine whether the next DL communication is initiated.

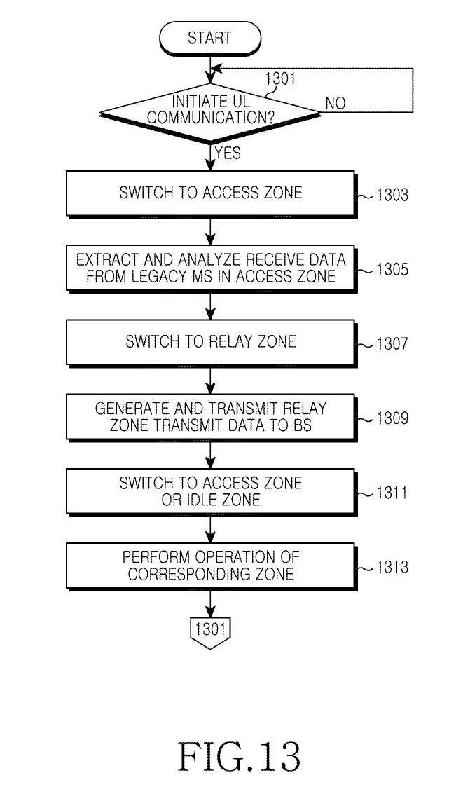

FIG. 13 is a flowchart outlining a DL communication method of an RS of a legacy system in a multihop relay broadband wireless communication system according to another exemplary embodiment of the present invention, that is, the UL communication method of the legacy RS with the frame structure illustrated in FIG. 4.

In step 1301, the legacy RS determines whether the UL communication is initiated.

When the UL communication commences, the legacy RS switches to the access zone in step 1303. That is, the legacy RS prepares for the access zone UL communication. For example, the preparation includes the transition between the transmission and the reception, the permutation setup change, and so on.

In step 1305, the legacy RS extracts the receive data of the legacy MS in the access zone and analyzes the receive data by demodulating and decoding the extracted receive data.

When the access zone communication finishes, the legacy RS switches to the relay zone in step 1307. That is, the legacy RS prepares for the relay zone UL communication.

In step 1309, the legacy RS generates and transmits the relay zone transmit data to the BS by mapping the generated transmit data to the relay zone.

When the relay zone communication is finished, the legacy RS switches to the access zone or the idle zone in step 1311.

Next, the legacy RS performs the operation of the corresponding zone in step 1313 and goes back to step 1301 to examine whether the next UL communication is initiated.

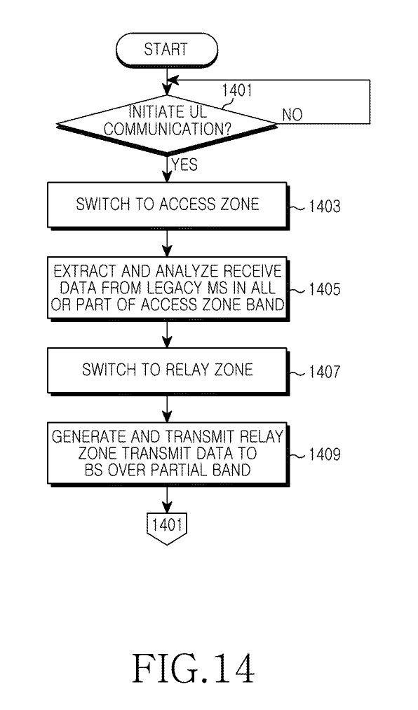

FIG. 14 is a flowchart outlining a UL communication method of an RS of a legacy system in a multihop relay broadband wireless communication system according to an exemplary embodiment of the present invention, that is, the UL communication method of the legacy RS with the frame structure illustrated in FIG. 5.

In step 1401, the legacy RS determines whether the UL communication is initiated.

When the UL communication commences, the legacy RS switches to the access zone in step 1403. That is, the legacy RS prepares for the access zone UL communication.

In step 1405, the legacy RS extracts the receive data of the legacy MS in the entire or partial access zone band and analyzes the receive data by demodulating and decoding the extracted receive data.

When the access zone communication ends, the legacy RS switches to the relay zone in step 1407. That is, the legacy RS prepares for the relay zone UL communication.

In step 1409, the legacy RS generates and transmits the relay zone transmit data to the BS by mapping the generated transmit data to part of the relay zone band. When the relay zone communication is finished, the legacy RS goes back to step 1401 to examine whether the next UL communication is initiated.

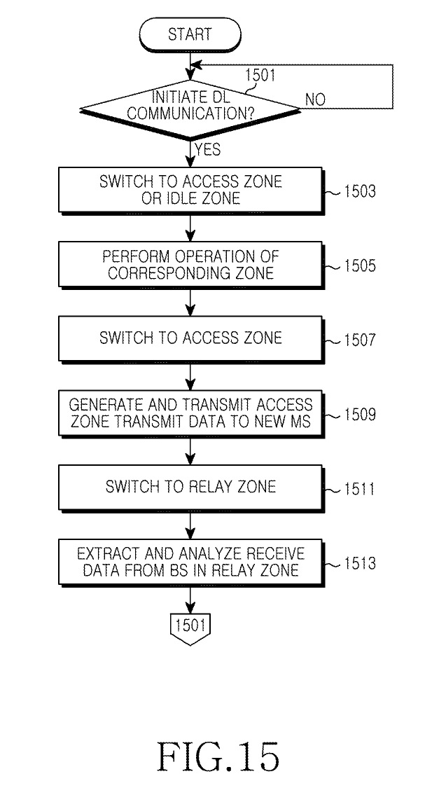

FIG. 15 is a flowchart outlining a DL communication method of an RS of a new system in a multihop relay broadband wireless communication system according to an exemplary embodiment of the present invention, that is, the DL communication method of the new RS with the frame structure illustrated in FIG. 3.

In step 1501, the new RS determines whether the DL communication is initiated.

When the DL communication commences, the new RS switches to the access zone or the idle zone in step 1503.

In step 1505, the new RS performs the operation of the corresponding zone. For example, the new RS does not transmit and receive the signal in the idle zone, and the new RS transmits the signal to the new MS in the access zone.

In step 1507, the new RS switches to the access zone. That is, the legacy RS prepares for the access zone DL communication. For example, the preparation includes the transition between the transmission and the reception, the permutation setup change, and so on.

In step 1509, the new RS generates the access zone transmit data and relays the generated transmit data to the new MS by mapping the transmit data to the access zone.

When the access zone communication finishes, the new RS switches to the relay zone in step 1511. That is, the new RS prepares for the relay zone DL communication.

In step 1513, the new RS extracts the receive data of the BS in the relay zone and analyzes the receive data by demodulating and decoding the extracted receive data. When the relay zone communication is finished, the new RS goes back to step 1501 to examine whether the next DL communication is initiated.

In FIG. 15, the new RS switches to the access zone or the idle zone and then to the access zone. This implies that there are one or more access zones. The access zone is provided at the end of the process illustrated in FIG. 15. Note that the access zone may precede the idle zone, the idle zone may come last, or there may not be an idle zone.

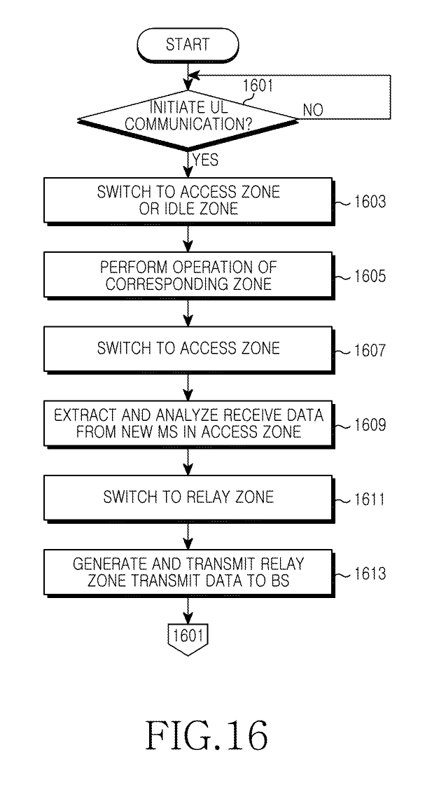

FIG. 16 illustrates a UL communication method of an RS of a new system in a multihop relay broadband wireless communication system according to an exemplary embodiment of the present invention, that is, the UL communication method of the new RS with the frame structure illustrated in FIG. 4.

In step 1601, the new RS determines whether the UL communication is initiated.

When the UL communication commences, the new RS switches to the access zone or the idle zone in step 1603.

In step 1605, the new RS performs the operation of the corresponding zone. For example, the new RS does not transmit and receive the signal in the idle zone, and the new RS receives the signal from the new MS in the access zone.

In step 1607, the new RS switches to the access zone. That is, the legacy RS prepares for the access zone UL communication. For example, the preparation includes the transition between the transmission and the reception, the permutation setup change, and so on.

In step 1609, the new RS extracts the receive data of the new MS in the access zone and analyzes the receive data by demodulating and decoding the extracted receive data.

When the access zone communication is finished, the new RS switches to the relay zone in step 1611. That is, the new RS prepares for the relay zone UL communication.

In step 1613, the new RS generates the relay zone transmit data and transmits the generated transmit data to the BS by mapping the transmit data to the relay zone. When the relay zone communication is finished, the new RS goes back to step 1601 to examine whether the next UL communication is initiated.

In FIG. 16, the new RS switches to the access zone or the idle zone and then to the access zone. This implies that there are one or more access zones. The access zone is provided at the end of the process illustrated in FIG. 16. Note that the access zone may precede the idle zone, the idle zone may come last, or there may not be an idle zone.

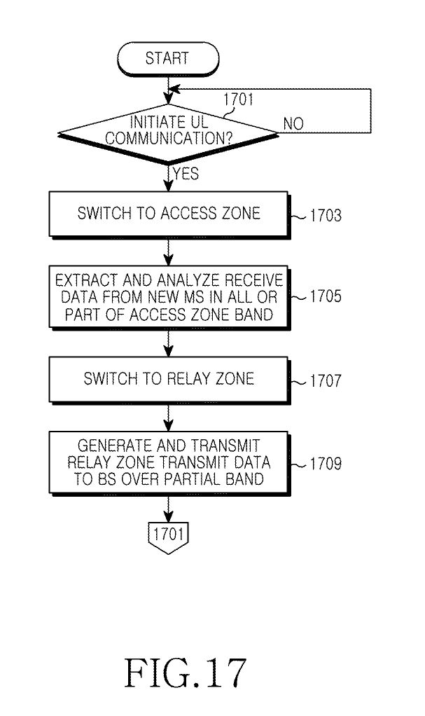

FIG. 17 is a flowchart outlining a UL communication method of an RS of a new system in a multihop relay broadband wireless communication system according to another exemplary embodiment of the present invention, that is, the UL communication method of the new RS with the frame structure illustrated in FIG. 5.

In step 1701, the new RS determines whether the UL communication is initiated.

When the UL communication commences, the new RS switches to the access zone in step 1703. That is, the new RS prepares for the access zone UL communication.

In step 1705, the new RS extracts the receive data of the new MS in the entire or partial access zone band and analyzes the receive data by demodulating and decoding the extracted receive data.

When the access zone communication finishes, the new RS switches to the relay zone in step 1707. That is, the new RS prepares for the relay zone UL communication.

In step 1709, the new RS generates and transmits the relay zone transmit data to the BS by mapping the generated transmit data to part of the relay zone band. When the relay zone communication is finished, the new RS goes back to step 1701 to examine whether the next UL communication is initiated.

In exemplary embodiments of the present invention, a 2-hop communication where a single legacy RS lies between a BS and a legacy MS and a 2-hop communication where a new RS lies between a BS and a new MS are assumed. It should be appreciated that the present invention is applicable to multihop communication where two or more legacy RSs lie between a BS and a legacy MS and to multihop communication where two or more new RSs lie between a BS and a new MS.

As set forth above, in a multihop relay broadband wireless communication system, frame structures are defined to support the communication with an entity of a heterogeneous system. Therefore, a data service may be efficiently provided to all MSs that are compliant with different systems.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A DownLink (DL) communication method of a Base Station (BS) in a multihop relay broadband wireless communication system, a DL period of the BS comprising a legacy zone for communicating with entities of a legacy system and a new zone for communicating with entities of a new system, the method comprising:
transmitting DL data to at least one entity of the legacy system via the legacy zone; and
transmitting DL data to at least one entity of the new system via the new zone which follows the legacy zone in a time axis.

2. The method of claim 1, wherein the transmitting of the DL data to at least one entity of the new system via the new zone comprises:
transmitting DL data to a Mobile Station (MS) of the new system via a new access zone for communicating with an MS of the new system; and
transmitting DL data to a Relay Station (RS) of the new system via a new relay zone which follows the new access zone in the time axis for communicating with an RS of the new system.

3. The method of claim 2, wherein the transmitting of the DL data to at least one entity of the legacy system via the legacy zone comprises:
transmitting DL data to an MS of the legacy system via a legacy access zone for communicating with an MS of the legacy system; and
transmitting DL data to an RS of the legacy system via a legacy relay zone which follows the legacy access zone in the time axis for communicating with an RS of the legacy system.

4. An UpLink (UL) communication method of a Base Station (BS) in a multihop relay broadband wireless communication system, a UL period of the BS comprising a legacy zone for communicating with entities of a legacy system and a new zone for communicating with entities of a new system, the method comprising:
receiving UL data from at least one entity of the legacy system via the legacy zone; and
receiving UL data from at least one entity of the new system via the new zone.

5. The method of claim 4, wherein the receiving of the UL data from at least one entity of the new system via the new zone comprises:
receiving UL data from a Mobile Station (MS) of the new system via a new access zone for communicating with an MS of the new system; and
receiving UL data from a Relay Station (RS) of the new system via a new relay zone which follows the new access zone in a time axis for communicating with an RS of the new system.

6. The method of claim 5, wherein the receiving of the UL data from at least one entity of the legacy system via the legacy zone comprises:
receiving UL data from an MS of the legacy system via a legacy access zone for communicating with an MS of the legacy system; and
receiving UL data from an RS of the legacy system via a legacy relay zone which follows the legacy access zone in the time axis for communicating with an RS of the legacy system.

7. The method of claim 5, wherein the legacy zone and the new zone are one of frequency division multiplexed and time division multiplexed.

8. A DownLink (DL) communication method of a new Relay Station (RS) in a multihop relay broadband wireless communication system, a DL period of the new RS comprising at least one of at least one new access zone for communicating with a new Mobile Station (MS) and a new relay zone for communicating with a Base Station (BS) according to a new system standard, the method comprising:
transmitting DL data to at least one new MS via the at least one new access zone; and
receiving DL data destined for at least one new MS from the BS via the new relay zone which follows the at least one new access zone in a time axis.

9. An UpLink (UL) communication method of a new Relay Station (RS) in a multihop relay broadband wireless communication system, a UL period of the new RS comprising at least one new access zone for communicating with a new Mobile Station (MS) and a new relay zone for communicating with a Base Station (BS) according to a new system standard, the method comprising:
receiving UL data from at least one new MS via the at least one new access zone; and
transmitting the UL data from at least one new MS to the BS via the new relay zone which follows the at least one new access zone in a time axis.

10. The method of claim 9, wherein the transmitting of the UL data from at least one new MS to the BS via the new relay zone comprises:
transmitting the UL data using only a partial band of a new zone allocated for entities of a new system in the entire band of the UL period.

11. A DownLink (DL) communication apparatus of a Base Station (BS) in a multihop relay broadband wireless communication system, a DL period of the BS comprising a legacy zone for communicating with entities of a legacy system and a new zone for communicating with entities of a new system, the apparatus comprising:
a mapper for mapping a DL data signal destined for the entities of the legacy system into the legacy zone, and for mapping a DL data signal destined for at least one entity of the new system into the new zone which follows the legacy zone in a time axis; and
a transmitter for transmitting the DL data signals.

12. The apparatus of claim 11, wherein the mapper maps a DL data signal destined to at least one MS of the new system into a new access zone for communicating at least one MS of the new system, and maps a DL data signal destined for at least one Relay Station (RS) of the new system into a new relay zone which follows the new access zone in the time axis for communicating with at least one RS of the new system.

13. The apparatus of claim 12, wherein the mapper maps a DL data signal destined for at least one MS of the legacy system into a legacy access zone for communicating at least one MS of the legacy system, and maps a DL data signal destined for at least one RS of the legacy system into a legacy relay zone which follows the legacy access zone in the time axis for communicating with at least one RS of the legacy system.

14. An UpLink (UL) communication apparatus of a Base Station (BS) in a multihop relay broadband wireless communication system, a UL period of the BS comprising a legacy zone for communicating with at least one entity of a legacy system and a new zone for communicating with at least one entity of a new system, the apparatus comprising:
a receiver for receiving UL data signals; and
a demapper for extracting UL data signals from at least one entity of the legacy system in the legacy zone, and for extracting UL data signals from at least one entity of the new system in the new zone.

15. The apparatus of claim 14, wherein the demapper extracts a UL data signal from at least one Mobile Station (MS) of the new system in a new access zone for communicating with at least one MS of the new system, and extracts a UL data signal from at least one Relay Station (RS) of the new system in a new relay zone which follows the new access zone in a time axis for communicating with at least one RS of the new system.

16. The apparatus of claim 15, wherein the demapper extracts a UL data signal from at least one MS of the legacy system in a legacy access zone for communicating with at least one MS of the legacy system, and extracts a UL data signal from at least one RS of the legacy system in a legacy relay zone which follows the legacy access zone in the time axis for communicating with at least one RS of the legacy system.

17. The apparatus of claim 15, wherein the legacy zone and the new zone are one of frequency division multiplexed and time division multiplexed.

18. A communication apparatus of a new Relay Station (RS) in a multihop relay broadband wireless communication system, a DL period of the new RS comprising at least one of a new access zone for communicating with a new Mobile Station (MS) and a new relay zone for communicating with a Base Station (BS) according to a new system standard, the apparatus comprising:
a mapper for mapping a DL data signal destined for at least one new MS into the at least one new access zone; and
a demapper for extracting DL data received from the BS and destined for at least one new MS in the new relay zone which follows the at least one new access zone in a time axis.

19. A communication apparatus of a new Relay Station (RS) in a multihop relay broadband wireless communication system, a UL period of the new RS comprising at least one new access zone for communicating with a new Mobile Station (MS) and a new relay zone for communicating with a Base Station (BS) according to a new system standard, the apparatus comprising:
a demapper for extracting a UL data signal from at least one new MS in the at least new access zone; and
a demapper for mapping the UL data signal received from at least one new MS and destined for the BS into the new relay zone which follows the at least one new access zone in the time axis.

20. The apparatus of claim 19, wherein the mapper maps the UL data signal only to a partial band of a new zone allocated for at least one entity of a new system in the entire band of the UL period.

21. A multihop relay broadband wireless communication system, the system comprising:
a Base Station (BS) for, in a DownLink (DL) period, transmitting DL signals to at least one entity of a legacy system via a legacy zone for communicating with at least one entity of the legacy system, and for transmitting DL signals to at least one entity of a new system via a new zone for communicating with at least one entity of the new system, the new zone following the legacy zone in a time axis;
a legacy Relay Station (RS) for receiving a DL signal from the BS via a legacy relay zone which occupies part of the same time zone as the legacy zone, and for transmitting a DL signal to at least one legacy Mobile Station (MS) via at least one legacy access zone which occupies all or part of another time zone excluding the legacy relay zone; and
a new RS for receiving a DL signal from the BS via a new relay zone which occupies a rear end of the same time zone as the new zone in the time axis, and for transmitting a DL signal to at least one new MS via at least one new access zone which occupies all or part of another time zone excluding the new relay zone.

22. A multihop relay broadband wireless communication system, the system comprising:
a Base Station (BS) for, in a UpLink (UL) period, receiving UL signals from entities of a legacy system via a legacy zone for communicating with at least one entity of the legacy system, and for receiving UL signals from at least one entity of a new system via a new zone for communicating with entities of the new system, the new zone following the legacy zone in a time axis;
a legacy Relay Station (RS) for transmitting a UL signal to the BS via a legacy relay zone which occupies part of the same time zone as the legacy zone, and for receiving a UL signal from at least one legacy Mobile Station (MS) via at least one legacy access zone which occupies all or part of another time zone excluding the legacy relay zone; and
a new RS for transmitting a UL signal to the BS via a new relay zone which occupies a rear end of the same time zone as the new zone in the time axis, and for receiving a UL signal from at least one new MS via at least one new access zone which occupies all or part of another time zone excluding the new relay zone.

23. A multihop relay broadband wireless communication system, the system comprising:
a Base Station (BS) for, in a UpLink (UL) period, receiving UL signals from entities of a legacy system via a legacy zone for communicating with at least one entity of the legacy system, and for receiving UL signals from at least one entity of a new system via a new zone for communicating with at least one entity of the new system, the new zone multiplexed with the legacy zone in a frequency axis;
a legacy Relay Station (RS) for transmitting a UL signal to the BS via a legacy relay zone which occupies a rear end of a band of the legacy zone in the time axis, and for receiving a UL signal from at least one legacy Mobile Station (MS) via at least one legacy access zone which occupies all or part of another time zone excluding the legacy relay zone; and
a new RS for transmitting a UL signal to the BS via a new relay zone which occupies a rear end of a band of the new zone in the time axis, and for receiving a UL signal from at least one new MS via at least one new access zone which occupies all or part of another time zone excluding the new relay zone.
